(19) United States
(12) Patent Application Publication
(10) Pub. No.: US 2025/0304353 A1
(43) Pub. Date: Oct. 2, 2025

(54) ANTIMICROBIAL BOTTLE WITH ANTIMICROBIAL SEAL

(71) Applicant: Microban Products Company, Huntersville, NC (US)

(72) Inventors: Jonathan Robert Clapp, Leicestershire (GB); Ivan Wei Kang Ong, Charlotte, NC (US); Glenner Marie Richards, Davidson, NC (US)

(21) Appl. No.: 19/195,155

(22) Filed: Apr. 30, 2025

Related U.S. Application Data
(63) Continuation-in-part of application No. 18/432,605, filed on Feb. 5, 2024.
Application No. 18/432,605 is a continuation of application No. 16/154,040, filed on Oct. 8, 2018, now Pat. No. 11,926,463.
(60) Provisional application No. 62/569,654, filed on Oct. 9, 2017.

(51) Int. Cl. B65D 81/28; A01N 25/34; A01N 31/16; A01N 43/40; A01N 59/16; B65D 1/02; B65D 23/02; B65D 41/04; B65D 41/34

(52) U.S. Cl. CPC B65D 81/28; A01N 25/34; A01N 31/16; A01N 43/40; A01N 59/16; B65D 1/0207; B65D 23/02; B65D 41/0442; B65D 41/045; B65D 41/3409; B65D 2251/20; B65D 2555/02

(57) ABSTRACT

A bottle having an antimicrobial property is provided. The bottle has one or more components including a body, a cap, a seal, and a locking ring. One or more of the components of the bottle are treated with an antimicrobial agent or comprise an antimicrobial agent. The antimicrobial agent is a silver-based antimicrobial, a silver-glass antimicrobial, or other antimicrobial.

### CROSS-REFERENCE TO RELATED APPLICATIONS

This application is a continuation-in-part of U.S. patent application Ser. No. 18/432,605, which is a continuation of U.S. patent application Ser. No. 16/154,040, now issued as U.S. Pat. No. 11,926,423, filed Feb. 5, 2024, which claims priority from provisional U.S. Patent Application Ser. No. 62/569,654, filed Oct. 9, 2017 in the United States Patent and Trademark Office. The disclosure of which is incorporated by reference in its entirety.

### FIELD OF THE INVENTION

The present invention relates to a bottle having an antimicrobial property, more particularly to a bottle having an antimicrobial property in its body, walls, cap, locking ring, and/or a seal.

### BACKGROUND OF THE INVENTION

According to recent research and published articles, bottled water contains more bacteria than tap water and some brands have been found to harbor levels 100 time above permitted levels.

In a study conducted by Texas Southern University, 35 different brands of bottled water were tested for biological contamination and other national and international guidelines for drinking water quality. The types of water tested included 16 types of spring water, 11 identified as purified and/or fortified tap water, five were carbonated water and three were distilled water. The study indicated that six spring waters and three brands of bottled tap water showed minor bacterial contamination. However, none of the carbonated or distilled waters were found to contain detectable levels of bacteria. The identified bacteria in the spring waters included five types of Gram-negative bacteria (i.e. Klebsiella terrigena, Ralstonia pickettii, Acidovorax temperans, and Acidovorax delafieldii and Agrobacterium rhizogenes) and two types of Gram-positives (i.e. Burkholderia glumae and Bacillus Thermoglucosidasius).

Bacteria can exhibit motility by moving from outside surface of a bottle to the inside. Current seals might afford insufficient protection. Once it encounters the packaged liquid (e.g. milk, water), the bacteria can multiply and lead to spoilage.

In addition to bacterial motility, the packaging materials (bottles, caps, seals) can become contaminated with microbes during the manufacturing process. Most companies conduct injection and blow molding of their materials in clean rooms, but there can be opportunistic contamination of surfaces by bacteria.

Thus, there is a need for an improved bottle that has a reduced risk of infiltration by bacteria and extends the shelf life of the packaged liquid contained therein.

The present invention relates to an antimicrobial bottle and seal.

In an embodiment of the invention, a bottle having an antimicrobial property comprises a body having a mouth, a neck, a shoulder, and a wall; a cap for attachment to the body; a seal located within the cap; and a locking ring for attachment to the cap, wherein an antimicrobial agent is present in a component of the bottle selected from the group consisting of the body, the cap, the seal, the locking ring, and a combination thereof.

In an embodiment of the invention, a bottle having an antimicrobial property comprises a body having a mouth, a neck, a shoulder, and a wall; a cap for attachment to the body; a seal located within the cap; and a locking ring attached to the cap, wherein a component of the bottle selected from the group consisting of the body, the cap, the seal, the locking ring, and a combination thereof is surface treated with an antimicrobial agent.

In an embodiment of the invention, a seal for a bottle comprises an antimicrobial agent.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is an illustration of a bottle having an antimicrobial property with a cap having an antimicrobial property attached thereto, in accordance with the present invention.

FIG. 2 is an illustration of a seal having an antimicrobial property for use in the cap of FIG. 1.

FIG. 3 is a sectional view of the cap shown in FIG. 1.

FIG. 4A is a bottom perspective view of a cap having an antimicrobial property according to another embodiment of the present invention, wherein a closure portion of the cap is in an open position.

FIG. 4B is a top perspective view of the cap of FIG. 4A.

FIG. 4C is a sectional view of the cap of FIGS. 4A and 4B, wherein the closure portion is in a closed position.

FIG. 4D is a sectional view of the cap of FIGS. 4A-4C, wherein the closure portion is in the open position.

FIG. 5A is a bottom perspective view of a cap having an antimicrobial property according to another embodiment of the present invention.

FIG. 5B is a top perspective view of the cap of FIG. 5A, wherein a closure portion of the cap is in a closed position.

FIG. 5C is a sectional view of the cap of FIGS. 5A and 5B, wherein the closure portion is in an open position.

FIG. 5D is a sectional view of the cap of FIGS. 5A-5C, wherein the closure portion is in the closed position.

FIG. 5E is an elevational view of the cap of FIGS. 5A-5D, wherein the closure position is in the closed position.

FIG. 6A is a bottom perspective view of a cap having an antimicrobial property according to another embodiment of the present invention, wherein a closure portion of the cap is in an open position.

FIG. 6B is a top perspective view of the cap of FIG. 6A.

FIG. 6C is a sectional view of the cap of FIGS. 6A and 6B, wherein the closure portion is not shown.

FIG. 6D is an elevational view of the cap of FIGS. 6A-6C, wherein the closure portion is in the closed position.

### DESCRIPTION OF THE PREFERRED EMBODIMENTS

The following description of the embodiments of the present invention is merely exemplary in nature and is in no way intended to limit the invention, its application, or uses. The present invention has broad potential application and utility, which is contemplated to be adaptable across a wide range of industries. The following description is provided herein solely by way of example for purposes of providing an enabling disclosure of the invention, but does not limit the scope or substance of the invention.

As used herein, the terms “microbe” or “microbial” should be interpreted to refer to any of the microscopic organisms studied by microbiologists or found in the use environment of a treated article. Such organisms include, but are not limited to, bacteria and fungi as well as other single-celled organisms such as mold, mildew and algae. Viral particles and other infectious agents are also included in the term microbe.

“Antimicrobial” further should be understood to encompass both microbicidal and microbistatic properties. That is, the term comprehends microbe killing, leading to a reduction in number of microbes, as well as a retarding effect of microbial growth, wherein numbers may remain more or less constant (but nonetheless allowing for slight increase/decrease).

For ease of discussion, this description uses the term antimicrobial to denote a broad-spectrum activity (e.g. against bacteria and fungi). When speaking of efficacy against a particular microorganism or taxonomic rank, the more focused term will be used (e.g. antifungal to denote efficacy against fungal growth in particular).

Using the above example, it should be understood that efficacy against fungi does not in any way preclude the possibility that the same antimicrobial composition may demonstrate efficacy against another class of microbes.

For example, discussion of the strong bacterial efficacy demonstrated by a disclosed embodiment should not be read to exclude that embodiment from also demonstrating antifungal activity. This method of presentation should not be interpreted as limiting the scope of the invention in any way.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular foitu. Throughout the specification and claims, the following teiins take at least the meanings explicitly associated herein, unless the context dictates otherwise. The meanings identified below do not necessarily limit the terms, but merely provided illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

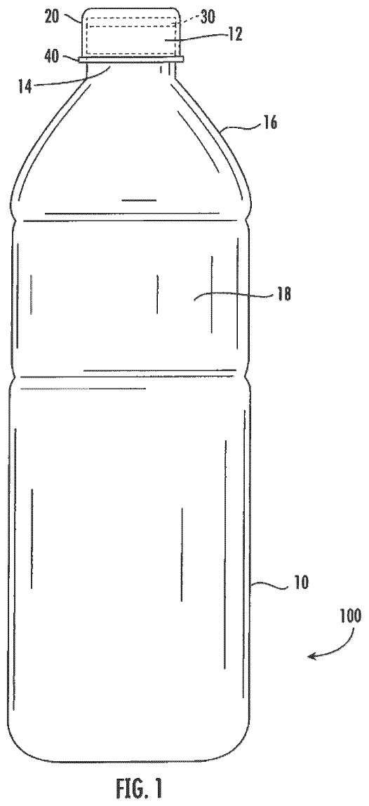

In an embodiment of the present invention, a bottle having an antimicrobial property is provided. Preferably, the bottle is for containing a beverage. Referring to the figures, FIG. 1 illustrates a bottle 100 having an antimicrobial property in accordance with the present invention. Bottle 100 has a body 10 having a mouth 12, a neck 14, a shoulder 16, and a wall 18, a cap 20, a seal 30, and a locking ring 40. Seal 30 is present in cap 20. Seal 30 is circular, preferably donut-shaped. The bottle may be of any size or shape. Preferred shapes are those that are typical for a water bottle or milk bottle.

Bottle 100 comprises a polymeric or a plastic material. Examples of such materials include, but are not limited to, polypropylene, low density polyethylene (LDPE), high density polyethylene (HDPE), polyethylene terephthalate, polypropylene, polycarbonate, copolyester (e,g., Eastman Tritan), polyvinyl chloride (PVC), polybutylene terephthalate (PBT), silicone, and combinations thereof. Preferably, bottle 100 comprises low density polyethylene or polyethylene terephthalate.

Cap 20 and locking ring 40 each comprise a polymeric or a plastic material. Examples of such materials include, but are not limited to, polypropylene, low density polyethylene (LDPE), high density polyethylene (HDPE), polyethylene terephthalate, polypropylene, polycarbonate, Tritan Copolyester (Eastman), polyvinyl chloride (PVC), polybutylene terephthalate (PBT), silicone, and combinations thereof. Preferably, cap 20 and locking ring 40 each comprise polypropylene.

An antimicrobial agent is present in bottle 100 in order to provide an antimicrobial property. More particularly, the antimicrobial agent is present in one or more components of the bottle 100. For example, the antimicrobial agent may be present in or applied to a component selected from the group consisting of body 10 including but not limited to wall 18, cap 20 and/or seal 30 inside of cap 20, seal 30, locking ring 40, and a combination thereof.

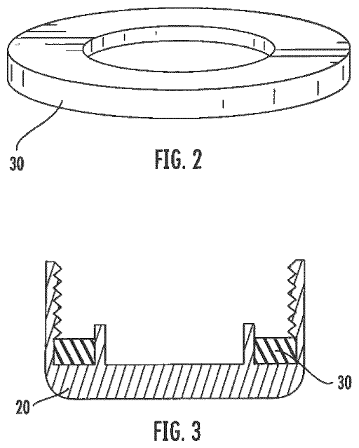

In an embodiment of the invention, seal 30 having an antimicrobial property and an elastic property is provided. FIG. 2 is an illustration of seal 30 for use in cap 20 of bottle 100 of FIG. 1. FIG. 3 is a sectional view of cap 20 shown in FIG. 1.

Seal 30 provides a sealed interface when cap 20 is tightened down to bottle 100 forcing motile external bacteria to encounter this interface and providing the surest protection. Non-limiting examples of materials for seal 30 are thermoplastic elastomer (TPE), polyurethane (PU), polyvinylchloride (PVC), and silicone.

In certain aspects, the antimicrobial agent comprises about 0.05 wt % to about 5.0 wt % of a masterbatch, with any endpoint falling within the above-mentioned broad range serving as endpoints for any additional sub-range occurring therein (e.g., 1 wt % to 4 wt %, 2 wt % to 3 wt %, etc.).

In certain aspects, the antimicrobial agent is a silver-glass antimicrobial. The silver-glass antimicrobials are MICROBAN® Additive IB10, MICROBAN® Additive IB12, MICROBAN® Additive IB14, MICROBAN® Additive IBIS, and similar variants. The silver-glass antimicrobial inhibits motility of bacteria into the inner contents of bottle 100 such as water.

In certain aspects, the antimicrobial agent is zinc pyrithione and/or triclosan.

In certain aspects, the antimicrobial agent is thiabendazole (Ultra-Fresh MS-25; CAS No. 148-79-8; Safety Data Sheet; Ultra Fresh (January 2024) incorporated by reference herein). Thiabendazole has a molecular weight of about 201.25 g/mol and a melting point ranging from about 297° C. to about 305° C. The thiabendazole is present (homogeneously dispersed) in the masterbatch at a concentration ranging from about 0.05 wt % to about 0.5 wt %, preferably about 0.1 wt % to about 0.3 wt %, with any endpoint falling within the above-mentioned broad range serving as endpoints for any additional sub-range occurring therein (e.g., 0.15 wt % to 0.2 wt %, 0.25 wt % to 0.3 wt %, etc.). If the thiabendazole concentrations fall below 0.05 wt %, the bottle and/or other components exhibit decreased anti-fungal efficacy and/or resistance. While if the thiabendazole concentrations exceed 5 wt %, the thiabendazole will migrate to the surface and will not be homogeneously dispersed throughout the bottle and/or other components. Furthermore, if the thiabendazole concentrations exceed 5 wt %, the bottle and/or other components become more opaque and negatively affects the utility of the bottle and/or components as well as the aesthetic appearance of the bottle and/or components. Thiabendazole provides increased anti-fungal efficacy. Thiabendazole provides anti-fungal activity, whereas the silver-glass antimicrobial mentioned above provides antibacterial activity. The zinc pyrithione and/or the triclosan mentioned above provide both antibacterial and/or anti-fungal activity. Thus, the antimicrobial agents disclosed provide a wide range of antimicrobial activity.

In some embodiments, the antimicrobial agent may be incorporated into the masterbatch that is added to the polymeric or plastic material. In other embodiments, the bottle and/or other components may be surface treated with the antimicrobial agent. In certain embodiments, the antimicrobial agent may be applied as a liquid or powder coating using any suitable means or method as desired, for example liquid dispersion. The liquid coating is dried after application to remove excess solvents. In certain embodiments, the thickness of the coating may be greater than about 40 μm. In some embodiments, the thiabendazole is incorporated into the bottle and/or other components using an injection molding process. In some embodiments, the thiabendazole is incorporated into the bottle and/or other components (i.e., homogeneously dispersed) using the following additive: 1-propene homopolymer, polypropylene and 5 wt % thiabendazole (MICROGUARD™ Polymer Additive IF1-5033-050; Safety Data Sheet; Microban (November 2024); incorporated by reference herein). In other embodiments, the thiabendazole is incorporated into a thermoplastic. In some embodiments, the thiabendazole is used in a powder form and/or a liquid form.

The antimicrobial bottle with antimicrobial seal and other components lengthen the shelf life of water and other liquid products (e.g. milk) that are susceptible to bacterial attack or spoilage. Lengthening of shelf life can translate to millions of dollars of savings down the beverage distribution chain and retailer. This invention makes liquid products safer and lowers incidence of food poisoning.

### Example 1

Shelf-life extension trials of HDPE blow molded bottles made with MICROBAN® Additive IB14 silver-glass antimicrobial were conducted. Initial trials show lengthening of shelf life of milk by over a week. The silver-glass antimicrobial was present in the masterbatch and was added in three different dosages of 1%, 3% and 5% to the walls of the bottles and in the caps. Pasteurised white milk was packed in the 2 L and 3 L HDPE bottles. Anti-microbial activity and efficacy using test method JIS Z2801 was conducted at about 35 degrees Celsius against Colifolm, Escherichia, Staphylococcus, Salmonella, and Listeria. Trials showed lengthening of shelf life of milk to at least 21 days of milk shelf life with the additive in the masterbatch.

### Example 2

The anti-fungal efficacy of the polypropylene cap containing thiabendazole was tested. The fungicidal activity was determined using the agar plate method AATCC 30 Part 3 (2017e). Individual plates of Malt Extract Agar (MEA) were inoculated with Aspergillus niger from primary stock cultures held at about 2° C. to about 8° C. and then incubated at about 30° C.±2° C. for up to 7 days to produce mature spores. A spore suspension was prepared from the plates in 10 mL aliquots of sterile distilled water (SDW) and filtered using glass wool. The spore suspension was adjusted using SDW so that it contained ≥10⁵ spores mL⁻¹. Two replicate sub-samples (i.e., the polypropylene cap with thiabendazole) were placed on the surface of individual MEA plates. A 100 μL aliquot of the spore suspension of Aspergillus niger was spread over the surface of both the sub-sample and the surrounding media. The sample plates were incubated for up to 7 days at about 30° C.±2° C. After incubation, the appearance of the plates were observed for zones of inhibition, macroscopic, and microscopic fungal growth to confirm the presence of fungal mycelia and/or spores.

An injection molded polypropylene cap treated with 2.0 wt % of Microban IF1-5033-050 (i.e., 0.1 wt % of thiabendazole) was tested with Aspergillus niger. The appearance of the plates were observed for fungal growth (i.e., microscopic growth and/or macroscopic growth). No surface growth was observed for either sub-sample or the surrounding media. Thus, the sub-sample containing 0.1 wt % thiabendazole exhibited anti-fungal efficacy and prevented growth of the fungal spores on and/or around the sub-sample.

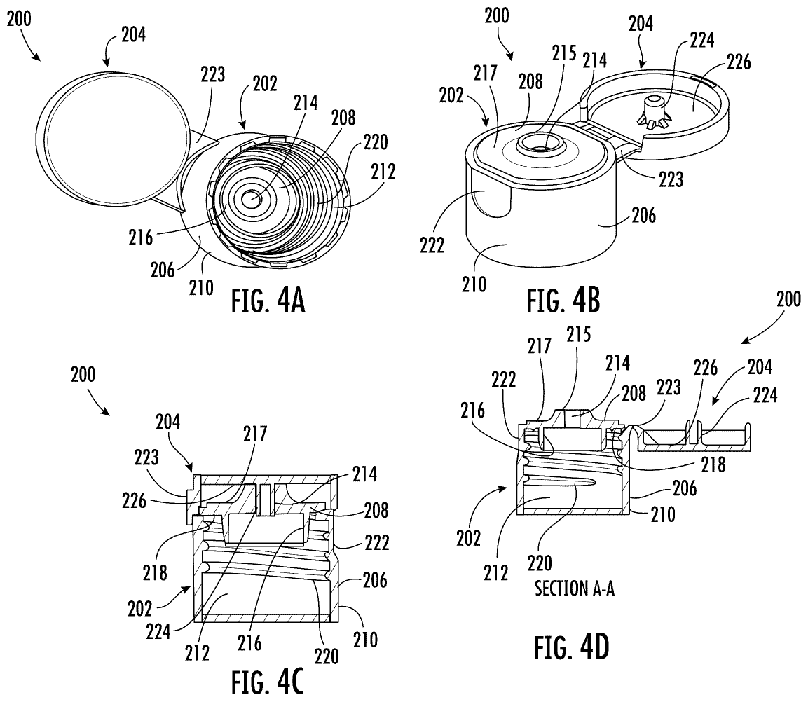

FIGS. 4A-4D illustrate a cap 200 for the bottle 100 according to another embodiment of the present disclosure. The cap 200 comprises an attachment portion 202 configured to be coupled to the neck of the bottle 100 and a closure portion 204 that can be selectively opened and closed. As shown, the attachment portion 202 is a generally hollow, cylindrical body 206. The body 206 may comprise an end wall 208 and an axially extending circumferential wall 210, which define a cavity 212. An aperture 214 may be formed in the end wall 208 to permit contents in the bottle 100 to flow therethrough and be dispensed. The aperture 214 shown has a generally uniform inner surface defining a substantially cylindrical shaped opening. It is understood, however, that the inner surface of the aperture 214 may vary if desired. In certain embodiments, the aperture 214 may be surrounded by a raised rim 215 formed in an outer surface 217 of the end wall 208.

In some embodiments, an inner wall 216 may extend axially from the end wall 208 into the cavity 212. The walls 208, 210, 216 may form a U-shaped annular channel 218 configured to receive a seal therein, for example the antimicrobial seat 30 described in more detail above, to keep containments out of the bottle 100. The seal 30 may form a substantially fluid-tight seal between the bottle 100 and the cap 200 to militate against a leakage of the contents from therebetween.

In certain embodiments, the attachment portion 202 may be configured to be releasably coupled to the bottle 100 by any suitable means and method. For example, the attachment portion 202 may be coupled to the bottle 100 by threaded engagement. As more clearly depicted in FIGS. 4C and 4D, an interior surface of the attachment portion 202 may include one or more grooves or internal threads 220 configured to engaged external threads formed on the neck of the bottle 100.

An indentation 222 provided on an exterior surface of the circumferential wall 210 of the body 206 allows easy disengagement of the closure portion 204 from the body 206 of the cap 200. An exterior surface of the indentation 222 may include surface irregularities (e.g., grooves, ribs, projections, protuberances, etc.) to provide grip and/or frictional interference to assist an opening of the closure portion 204.

In certain embodiments, the closure portion 204 may be pivotally coupled to the attachment portion 202 of the cap 200. For example, the closure portion 204 may be pivotably connected to the attachment portion 202 by a living hinge 223. The pivot connection of the closure portion 204 to the attachment portion 202 allows movement thereof between an open position, shown in FIGS. 4A, 4B and 4D, and a closed position, shown in FIG. 4C. In other embodiments, the closure portion 204 may be completely removable from the attachment portion 202 of the cap 200 to provide greater access to the contents of the bottle 100.

An axially extending protuberance 224 (i.e., a friction fit plug) may be formed on an inner surface 226 of the closure portion 204. The protuberance 224 has a size, shape, and configuration to be selectively received in the corresponding aperture 214 formed in the attachment portion 202. The protuberance 224 prevents the contents of the bottle 100 from inadvertently escaping the bottle 100 when the closure portion 204 is in the closed position as illustrated in FIG. 4C.

In particular embodiments, the cap 200 may be formed of a thermoplastic polymer resin known as polyethylene terephthalate (PET), which is a plastic material that can be used to create caps 200 in differing colors and appearances.

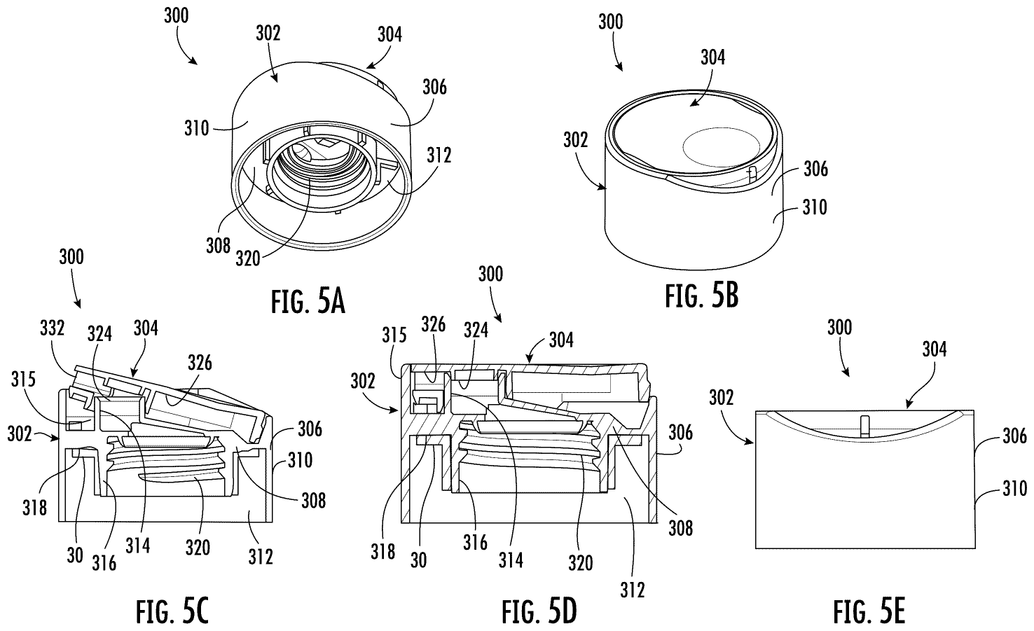

FIGS. 5A-5E illustrate a cap 300 for the bottle 100 according to another embodiment of the present disclosure. The cap 300 comprises an attachment portion 302 configured to be coupled to the neck of the bottle 100 and a closure portion 304 that can be selectively opened and closed. In certain embodiments, the cap 300 is a disc top cap that can be opened by delivering pressure to one side of the closure portion 304 of the cap 300 or closed by pressing down on an opposite side of the closure portion 304 of the cap 300.

As shown, the attachment portion 302 is a generally hollow, cylindrical body 306. The body 306 may comprise an end wall 308 and an axially extending circumferential wall 310, which define a cavity 312. An aperture 314 may be formed in the end wall 308 and/or by an axially extending portion 315 to permit contents in the bottle 100 to flow therethrough and be dispensed.

In some embodiments, an inner wall 316 may extend axially from the end wall 308 into the cavity 312. The walls 308, 310, 316 may form a U-shaped annular channel 318 configured to receive a seal therein, for example the antimicrobial seat 30 described in more detail above, to keep containments out of the bottle 100. The seal 30 may form a substantially fluid-tight seal between the bottle 100 and the cap 300 to militate against a leakage of the contents from therebetween.

In certain embodiments, the attachment portion 302 may be configured to be releasably coupled to the bottle 100 by any suitable means and method. For example, the attachment portion 302 may be coupled to the bottle 100 by threaded engagement. As more clearly depicted in FIGS. 5A, 5C, and 5D, an interior surface of the attachment portion 302 may include one or more grooves or internal threads 320 configured to engaged external threads formed on the neck of the bottle 100.

In certain embodiments, the closure portion 304 may be pivotally coupled to the attachment portion 302 of the cap 300. For example, the closure portion 304 may be pivotably connected to the attachment portion 302 by an interference fit. The pivot connection of the closure portion 304 to the attachment portion 302 allows movement thereof between an open position, shown in FIGS. 5C, and a closed position, shown in FIGS. 5B, 5D, and 5E. In other embodiments, the closure portion 304 may be completely removable from the attachment portion 302 of the cap 300 to provide greater access to the contents of the bottle 100.

An axially extending protuberance 324 (i.e., a friction fit plug) may be formed on an inner surface 326 of the closure portion 304. The protuberance 324 has a size, shape, and configuration to be selectively received in the corresponding aperture 314 formed in the attachment portion 302. The protuberance 324 prevents the contents of the bottle 100 from inadvertently escaping the bottle 100 when the closure portion 304 is in the closed position as best shown illustrated in FIG. 5D.

In some embodiments, an aperture 332 may be formed in the closure portion 304. The aperture 332 is in fluid communication with the aperture 314 with the interior of the bottle 100 when the closure portion 304 is in the open position to allow the contents of the bottle 100 to be dispensed.

In particular embodiments, the cap 300 may be formed of a thermoplastic polymer resin known as polyethylene terephthalate (PET), which is a plastic material that can be used to create caps 400 in differing colors and appearances.

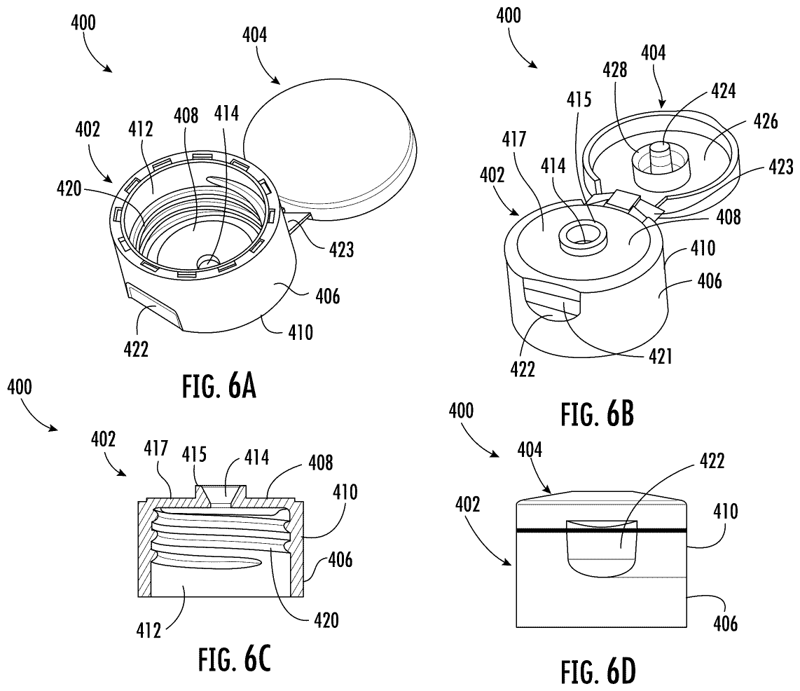

FIGS. 6A-6D illustrate a cap 400 for the bottle 100 according to another embodiment of the present disclosure. The cap 400 comprises an attachment portion 402 configured to be coupled to the neck of the bottle 100 and a closure portion 404 that can be selectively opened and closed. As shown, the attachment portion 402 is a generally hollow, cylindrical body 406. The body 406 may comprise an end wall 408 and an axially extending circumferential wall 410, which define a cavity 412. An aperture 414 may be formed in the end wall 408 to permit contents in the bottle 100 to flow therethrough and be dispensed. The aperture 414 shown has a generally inwardly tapered inner surface forming a substantially frustoconical shaped opening. It is understood, however, that the inner surface of the aperture 414 may uniform if desired. In certain embodiments, the aperture 414 may be surrounded by a raised rim 415 formed in an outer surface 417 of the end wall 408.

In some embodiments, the wall 408 and/or the wall 410 may be configured to receive a seal therein, for example the antimicrobial seat 30 described in more detail above, to keep containments out of the bottle 100. The seal 30 may form a substantially fluid-tight seal between the bottle 100 and the cap 400 to militate against a leakage of the contents from therebetween.

In certain embodiments, the attachment portion 402 may be configured to be releasably coupled to the bottle 100 by any suitable means and method. For example, the attachment portion 402 may be coupled to the bottle 100 by threaded engagement. As more clearly depicted in FIGS. 6A and 6C, an interior surface of the attachment portion 402 may include one or more grooves or internal threads 420 configured to engaged external threads formed on the neck of the bottle 100.

An indentation 422 provided on an exterior surface of the circumferential wall 410 of the body 406 allows easy disengagement of the closure portion 404 from the body 406 of the cap 400. An exterior surface of the indentation 422 may include surface irregularities 421 (e.g., grooves, ribs, projections, protuberances, etc.) to provide grip and/or frictional interference to assist an opening of the closure portion 404.

In certain embodiments, the closure portion 404 may be pivotally coupled to the attachment portion 402 of the cap 400. For example, the closure portion 404 may be pivotably connected to the attachment portion 402 by a living hinge 423. The pivot connection of the closure portion 404 to the attachment portion 402 allows movement thereof between an open position, shown in FIGS. 6A and 6B, and a closed position, shown in FIG. 6D. In other embodiments, the closure portion 404 may be completely removable from the attachment portion 402 of the cap 400 to provide greater access to the contents of the bottle 100.

An axially extending protuberance 424 (i.e., a friction fit plug) may be formed on an inner surface 426 of the closure portion 404. The protuberance 424 has a size, shape, and configuration to be selectively received in the corresponding aperture 414 formed in the attachment portion 402. In some embodiments, the protuberance 424 has an inwardly tapered outer surface corresponding to the inner surface of the aperture 414. The protuberance 424 prevents the contents of the bottle 100 from inadvertently escaping the bottle 100 when the closure portion 404 is in the closed position as illustrated in FIG. 6D.

In some embodiments, an axially extending inner wall 428 may be formed on the inner surface 426 of the closure portion 404 to surround the protuberance 424. In certain instances, the protuberance 424 and the inner wall 428 are sized, shaped, and configured to receive the raised rim 415 of the attachment portion 402 therebetween to further prevent the contents of the bottle 100 from inadvertently escaping the bottle 100 when the closure portion 404 is in the closed position.

In particular embodiments, the cap 400 may be formed of a thermoplastic polymer resin known as polyethylene terephthalate (PET), which is a plastic material that can be used to create caps 400 in differing colors and appearances.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A bottle having an antimicrobial property for reducing food spoilage in the bottle and increasing shelf life of the food in the bottle comprising:
a body having a wall,
a cap for attachment to the body,
wherein an antimicrobial agent is present in the wall of the body and/or in the cap,
wherein the antimicrobial agent is selected from the group consisting of a silver-based antimicrobial, a silver-glass antimicrobial, zinc pyrithione, triclosan, thiabendazole, and a combination thereof.

2. The bottle according to claim 1, further comprising a seal disposed in the cap.

3. The bottle according to claim 2, wherein the antimicrobial agent is present in the seal.

4. The bottle according to claim 1, wherein the bottle is comprised of a polymeric material.

5. The bottle according to claim 4, wherein the polymeric material is selected from the group consisting of polypropylene, low density polyethylene (LDPE), high density polyethylene (HDPE), polyethylene terephthalate, polypropylene, polycarbonate, copolyester, polyvinyl chloride (PVC), polybutylene terephthalate (PBT), silicone, and a combination thereof.

6. The bottle according to claim 2, wherein the seal has an elastic property.

7. The bottle according to claim 2, wherein the seal is comprised of a material selected from the group consisting of thermoplastic elastomer (TPE), polyurethane (PU), polyvinylchloride (PVC), silicone, and a combination thereof.

8. The bottle according to claim 1, wherein the thiabendazole is present at a concentration ranging from about 0.05 wt % to about 0.5 wt %.

9. A bottle having an antimicrobial property comprising:
a body,
a cap for attachment to the body,
wherein the body and/or the cap is surface treated with an antimicrobial agent,
wherein the antimicrobial agent is selected from the group consisting of a silver-based antimicrobial, a silver-glass antimicrobial, zinc pyrithione, triclosan, thiabendazole, and a combination thereof.

10. The bottle according to claim 9, wherein the bottle is comprised of a polymeric material.

11. The bottle according to claim 10, wherein the polymeric material is selected from the group consisting of polypropylene, low density polyethylene (LDPE), high density polyethylene (HDPE), polyethylene terephthalate, polypropylene, polycarbonate, copolyester, polyvinyl chloride (PVC), polybutylene terephthalate (PBT), silicone, and a combination thereof.

12. The bottle according to claim 9, further comprising a seal disposed in the cap.

13. The bottle according to claim 12, wherein the seal has an elastic property.

14. The bottle according to claim 12, wherein the seal is circular.

15. The bottle according to claim 12, wherein the seal is donut-shaped.

16. The bottle according to claim 12, wherein the seal is comprised of a material selected from the group consisting of thermoplastic elastomer (TPE), polyurethane (PU), polyvinylchloride (PVC), silicone, and a combination thereof.

17. The bottle according to claim 9, wherein the thiabendazole is present at a concentration ranging from about 0.05 wt % to about 0.5 wt %.

18. A bottle having an antimicrobial property comprising:
a body having a wall,
a cap for attachment to the body, and
a food safe liquid contained within the bottle,
wherein an antimicrobial agent is present in the wall of the body and/or the cap
wherein the antimicrobial agent is selected from the group consisting of a silver-based antimicrobial, a silver-glass antimicrobial, zinc pyrithione, triclosan, thiabendazole, and a combination thereof.

19. The bottle according to claim 18, wherein shelf life of the food safe liquid contained within the bottle is increased by over a week when compared to a bottle omitting the antimicrobial agent.

20. The bottle according to claim 18, wherein the thiabendazole is present at a concentration ranging from about 0.05 wt % to about 0.5 wt %.
